(19) United States
(12) Patent Application Publication
(10) Pub. No.: US 2004/0110019 A1
(43) Pub. Date: Jun. 10, 2004

(54) Multilayer film for label production

(75) Inventors: Edgar Schubert, Speyer (DE); Rainer Schumacher, Wolfenbuttel (DE)

Correspondence Address: FOLEY AND LARDNER, SUITE 500, 3000 K STREET NW, WASHINGTON, DC, 20007, US

(73) Assignee: RENOLIT AG

(21) Appl. No.: 10/724,639

(22) Filed: Dec. 2, 2003

(30) Foreign Application Priority Data
Jun. 25, 2002 (DE) 102 28 273.0

(51) Int. Cl. B32B 9/00

(52) U.S. Cl. 428/515; 428/40.1

(57) ABSTRACT

The present invention relates to a multilayer film for producing label material, comprising two outer layers (1, 5) of low-density polyethylene, a core layer (3) of highly crystalline polypropylene or of a blend with up to 20% of low-density polyethylene, and adhesion-promoting layers (2, 4) of polypropylene, wherein the adhesion-promoting layers contain 5-30% of ULDPE (d ≦0.9), 0-25% of LDPE and 20-95% of a random copolymer of polypropylene with a 1-alkylene having 4-20 carbon atoms, and to a process for producing such films.

### CROSS-REFERENCE TO RELATED PATENT APPLICATIONS

The disclosure of German Patent Application 102 28 273.0, filed Jun. 25, 2002, including the specification, drawings, claims and abstract, is hereby incorporated by reference in its entirety.

### BACKGROUND OF THE INVENTION

The present invention relates to a multilayer film for label production, comprising two outer layers of polyethylene and a core layer of polypropylene which are held together by adhesion-promoting layers.

Polymeric label films have been known for a long time in the art. Originally use was made of films of monoaxially or biaxially oriented polyesters or polypropylenes oriented in machine direction. The label film is printed and provided with an adhesive layer, and a release liner, composed of an abhesively coated film or paper, is applied. The assembled unit comprising release liner, adhesive layer, and label film is diecut in such a way that film and adhesive layer are separated but the release liner is retained as a continuous strip. The offcut is removed in the form of a diecut lattice, leaving a sequence of separate label sections on the release liner.

When the labels are applied to the substrate to be labeled the release liner is bent round with a small radius at a large angle, whereupon the relatively rigid label section is detached from the release liner and can be pressed onto the substrate. The rigidity of the label section must be such that the part of the label section partially detached from the release liner can be moved in “free-floating” fashion to the point of its placement onto the substrate to be labeled, without deviating from the intended path.

A disadvantage associated with the known films is that the adequate label section rigidity required for automatic labeling units is possessed only by certain polymeric materials, particularly those whose rigidity has been further increased by means of a costly orientation in machine direction. These materials include, for example, polypropylene or polyethylene terephthalate. Moreover, polymers of this kind have poor printing properties, so further necessitating the application of an expensive print primer.

Polymers which can be printed directly or following a corona treatment, such as polyethylene, on the other hand, are too soft and require considerable disadvantages to be accepted in connection with the production of label films.

Numerous attempts have therefore been made to produce label films by laminating or coextruding a relatively thick, rigid core layer of polypropylene or a polypropylene/polyethylene blend with a thin polyethylene layer, which is printable. In order to suppress the flexing or curling of the film in the course of the processing, so that it lies flat in the course of processing, a further polyethylene film is preferably also coextruded or laminated onto the reverse. Since the adhesion of polyethylene and polypropylene films to one another is poor, it is additionally known to incorporate between the above layers, in addition, a tie or sealing layer, composed of EVA, EMA or of a polypropylene/low-density polyethylene blend (cf. EP 0 950 511 A2, DE 198 59 789 C1, and WO 00/08622). In order to allow recycling of the label wastes it is preferred for the adhesion promoter layers, as well as the actual films, to be composed of polyolefin (cf. DE 1 98 59 789). Unfortunately, composite films of this kind made from polyolefins alone exhibit inadequate interply adhesion in the case of production by coextrusion, so that in the course of processing, particularly during the printing of the labels and their removal from the underlay, there are instances of partial detachment. Inadequate interply adhesion can be tested by pressing on an adhesive tape and removing it again, as a result of which the plies can be separated from one another partly or completely. This behavior is independent of the proportion in which polypropylene and polyethylene are blended with one another for use as tie layer.

### SUMMARY OF THE INVENTION

The object has therefore arisen of finding new adhesion promoters with which sufficient interply adhesion is achieved and which are composed of polyolefin, so as to allow recycling together with the other film materials.

In accomplishing the objects of the invention, there has been provided, according to one aspect of the invention, a multilayer film for producing label material, comprising two outer layers of low-density polyethylene, a core layer of highly crystalline polypropylene or of a blend with up to 20% of low-density polyethylene, and adhesion-promoting layers of polypropylene, wherein the adhesion-promoting layers comprise (i) 5-30% by weight of ULDPE (d≦0.875), (ii) 0-50% by weight of LDPE and/or LLDPE, and (iii) 20-95% by weight of a random copolymer of polypropylene with a 1-alkylene having 4-20 carbon atoms.

In accordance with other aspects of the invention, there are also provided labels comprising the multilayer film and a label affixed by an adhesive to a release liner made of abhesively coated film or paper wherein the label comprises the multilayer film.

According to another aspect of the invention, there is provided a process for producing a multilayer film, comprising shaping the polymer layers using a 5-layer coextrusion unit at temperatures of 200-250°C.; and solidifying the polymer layers using a chill roll having a surface temperature of 40-70° C.

In accordance with an additional aspect of the invention there has been provided an adhesion-promoting composition for multilayer films for label material, comprising (i) 5-30% by weight of ULDPE (d≦0.875), (ii) 0-50% by weight of LDPE and/or LLDPE, and (iii) 20-95% by weight of a random copolymer of polypropylene with a 1-alkylene having 4-20 carbon atoms.

Further objects features and advantages of the invention will become apparent from the detailed description of preferred embodiments that follows, when considered together with the accompanying drawing.

### BRIEF DESCRIPTION OF THE DRAWINGS

The invention is explained in detail below with reference to the exemplary embodiments and with reference to the accompanying drawings, in which:

The FIGURE shows an arrangement of 5 layers for the multilayer films discussed in the examples set forth hereinbelow.

### DETAILED DESCRIPTION OF THE PREFERRED EMBODIMENTS

In accordance with the main application DE 101 47 538.1-16 an adhesion-promoting blend of polypropylene and low-density polyethylene (LDPE) can be produced by mixing in an ultralow-density polyethylene (ULDPE). The adhesion-promoting layer in this case contains 20-50% by weight polypropylene, 60-25% LDPE and 15-30% ULDPE. Instead of LDPE it is also possible to use a linear low-density polyethylene (LLDPE).

It has now been found that an adhesion-promoting layer with which sufficient interply adhesion is achieved and which are composed of polyolefin, so as to allow recycling together with the other film materials can also be produced from a blend of polypropylene which as a random copolymer includes a linear 1-alkylene having 4-20 carbon atoms with an ultralow-density polyethylene (ULDPE). The blend may but need not include any LLDPE or LDPE, and allows the propylene fraction to be increased considerably as compared with the main application. The adhesion-promoting layer therefore preferably contains 20-95% by weight polypropylene copolymer, 5-30% by weight ULDPE, and 0-50% by weight LDPE or LLDPE.

The polypropylene copolymer of the adhesion promoter may be produced from 5-25% 1-alkylene monomers and 95-75% propylene monomers in the form of a random copolymer in a conventional manner using suitable catalysts, preferred comonomers range from butene to octene.

The core layer used for the multilayer film may be, for example, a standard commercial polypropylene. This standard commercial polypropylene may have a density of 0.90-0.92 g/cm², a melt index MFI 230° C./2.16 kg of 3-20, in particular 5-10 g/10 min, and a melting range of 150-180° C. To ensure sufficient rigidity of the core layer, the polypropylene ought further to have an elasticity modulus of more than 1 600 MPa, in particular of more than 1 800 MPa, and more preferably of (measured to ISO 178) 2 000-2 100 MPa.

As the outer layer, a standard commercial low-density polyethylene (LDPE or LLDPE) may be used for example. Those products possessing particular suitability for film formation preferably have a density of from 0.90 to 0.940 g/cm³, and in particular 0.925-0.940. These polyethylenes also preferably have a melt index, MFI, 190°C./2.16 kg of 0.1-22 g/10 min, with a melt index of 1-8 g/l0 min being particularly preferred. The melting range is preferably 100-135° C.

Where the adhesion-promoting layer includes LDPE, it is possible to use the same product as in the outer layer.

The ultralow-density polyethylene (ULDPE) of the adhesion-promoting layer preferably has a density of less than 0.90 g/cm³, particularly preferably less than or equal to 0.875 g/cm³. Melt index and melting range are preferably situated within the same range as indicated above for LDPE.

The core layer may, for example, be composed of a polypropylene composition as described above to which up to 20%, preferably 5-10%, of low-density polyethylene (LDPE) can be added in order to improve the breaking strength and elasticity. Larger amounts have an adverse effect on the film's rigidity. As polypropylene it is preferred to use a polypropylene of relatively high crystallinity, which has good rigidity in all directions and therefore need not be oriented by stretching. The polypropylene core layer is, preferably, normally 20-80 μm, particularly preferably 40-60 μm thick. In order to enhance the diecutting properties of these films, it is possible to include nucleating agents, resins, and other auxiliaries known for this purpose in the composition in amounts of up to 5%, preferably up to 1%, by weight.

As an example of the outer layers, a standard commercial low-density polyethylene (LDPE) of the above specification may be used. The thickness of these outer layers is preferably between 3 and 5 μm, more preferably 6-8 μm.

The tie layers may have a thickness of 2-10 μm, preferably about 6-8 μm.

The overall structure has a thickness of preferably 40-100 μm, with layer thicknesses of 60-80, um being particularly preferred. The elasticity modulus (tensile modulus, measured to DIN EN ISO 527-3/2/10) of the overall structure is preferably more than 1,000 MPa, more preferably 1,100-1,400 MPa.

To produce label films, one side of the assembly may also be provided with a standard adhesive and a release liner and the other outer layer may be corona-treated where appropriate for improved adhesion of the printing ink.

The five layers may be extruded using an appropriate 5-channel cassette at temperatures of approximately 200-260° C., preferably approximately 240° C. The assembly which emerges through a corresponding slot die may be taken off, for example, in free fail over a chill roll which has a surface temperature of 30-95° C., preferably 50-60° C., to give optically clear, firmly bonded, rigid films.

If desired, the above layers may also be colored using pigments or roughened and rendered opaque, and given additional rigidity, by means of fillers such as titanium dioxide or chalk. Reference is hereby made to the relevant measures of the prior art.

Examples

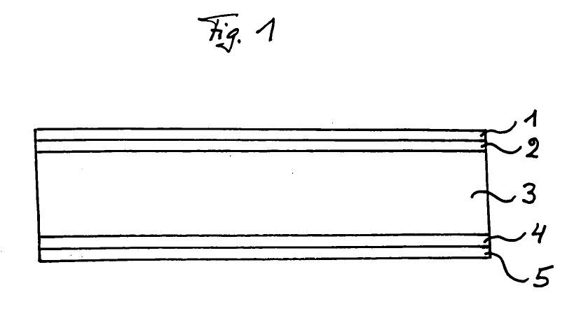

Polymer blends having the compositions stated in the table below are coextruded in a Reifenhäuser 5-layer coextrusion unit, with layer material C forming layers 1 and 5, material B layers 2 and 4, and material A layer 3, as shown in FIG. 1. Layers 1 and 5 have an average thickness of 7 μm, layers 2 and 4 an average thickness of 7 μm, and layer 3 an average thickness of 47 μm. The layer assembly, emerging from the extruder with a temperature of approximately 200-260° C., is cooled on a chill roll at a temperature of 50-60° C. and wound up for storage.

The rigidity of the films is determined on the basis of the elasticity modulus in accordance with the method of DIN EN ISO 527-3/2/10.

Interply adhesion in coextruded or multi-ply films:

Test equipment:Punching die 100×100 mm

Adhesive tape type 54108, 15 mm wide, from INTERTAPE

Sample preparation

A number of plies—approximately 25—of film are placed on top of one another and punched out with the punching die on a punch underlay.

The punched edges should be smooth and clean.

The top and bottom films are discarded.

Separate the films and take 2 film pieces.

Two individual film pieces are placed on the work plate of the test area (a hard, smooth underlay).

A total of 8 adhesive strips (type 54108) of 70 mm in length are half-adhered to the film edges as follows:

adhere adhesive strips to the corona-treated side (if treated)

4 strips at an angle of 30° along the edges of the 1st film piece

4 strips at an angle of 45° along the edges of the 2nd film piece

The adhesive strips are rubbed onto the film using a fingernail, with strong pressure.

After a waiting time of 20 seconds the adhesive tapes are stripped in a single rapid, continuous motion at an angle of 135°.

If the film is undamaged, at the edges in particular, after all 6 adhesive strips are removed, the test is deemed to have been passed and the notation “pos” is included in the table below.

As soon as removal of one adhesive strip resulted in parts of a film ply being extracted from the film, or whole layers being removed, the test is deemed to have been failed and the notation “neg” is entered in the table below.

The optical properties of the films are assessed by simple comparison with one another. It is particularly important here that there is minimal distortion of the background viewed through the film. A further criterion is that the films exhibit minimal haze. The degree of haze is determined on the basis of method ASTM D1003-92.

In the table below, nondistorting, nonhazy films are awarded the notation “pos” in the “Optical quality” line, and distorted or hazy films “neg”.

| | TABLE | | |
|---|---|---|---|
| | % by mass | | |
| Layer A | | | |
| PP (d = 0.9-0.91) | 98 | 98 | 88 |
| LDPE (d = 0.931) | | | 10 |
| LLDPE (d = 0.917) | 2 | 2 | |
| ULDPE (d = 0.87-0.875) | | | 2 |
| Layer B | | | |
| PPB (d = 0.9-0.91)* | 95 | 90 | 75 |
| LDPE (d = 0.931) | | | 15 |
| ULDPE (d = 0.87-0.875) | 5 | 10 | |
| Layer C | | | |
| LDPE (d = 0.931) | 100 | 100 | 100 |
| Result | | | |
| Interply adhesion | pos | pos | pos |
| Rigidity | pos | pos | pos |
| Optical quality | pos | pos | pos |

PPB is a random propene/butene copolymer containing 20% by weight butene.

The foregoing embodiments have been shown for illustrative purposes only and are not intended to limit the scope of the invention which is defined by the claims.

What is claimed is:

1. A multilayer film for producing label material, comprising:
a) two outer layers of low-density polyethylene;
b) a core layer of highly crystalline polypropylene or of a blend with up to 20% of low-density polyethylene; and
c) adhesion-promoting layers of polypropylene, wherein the adhesion-promoting layers comprise:
(i) 5-30% by weight of ULDPE (d≦0.875),
(ii) 0-50% by weight of LDPE and/or LLDPE, and
(iii) 20-95% by weight of a random copolymer of polypropylene with a 1-alkylene having 4-20 carbon atoms.

2. A multilayer film according to claim 1, wherein the total film thickness is approximately 40-100 μm and wherein the outer layers comprise 10-30% of the film thickness, the adhesion-promoting layers comprise 10-30% of the film thickness, and the core layer comprises 60-90% of the film thickness.

3. A multilayer film according to claim 1, wherein more than 80% by weight of the core layer comprises polypropylene having a density of 0.90-0.92 g/cm³, a melt index of 5-10 g/10 min (MFI 230° C./2.16 kg), a melting range of 150-180° C., and an elasticity modulus (ISO 178) of more than 1,600 MPa, in a blend with low-density polyethylene (LDPE) comprising a density of 0.90-0.940 g/cm³, a melt index of 0.1-22 g/10 min (MFI 190° C./2.16 kg), and a melting range of 100-135° C., in an amount of 2-20% by weight.

4. A multilayer film according to claim 1, wherein more than 80% by weight of the core layer comprises polypropylene having a density of 0.90-0.92 g/cm³, a melt index of 5-10 g/10 min (MFI 230° C./2.16 kg), a melting range of 150-180° C., and an elasticity modulus (ISO 178) of more than 2,000 MPa, in a blend with low-density polyethylene (LDPE) comprising a density of 0.90-0.940 g/cm³, a melt index of 0.1-22 g/10 min (MFI 190° C./2.16 kg), and a melting range of 100-135° C., in an amount of 2-20% by weight.

5. A multilayer film according to claim 1, wherein the outer layers comprise a low-density polyethylene (LDPE) or ultralow-density polyethylene having a density of from 0.90 to 0.940 g/cm³ a melt index MFI 190° C./2.16 kg of 0.1-22 g/10 min, and a melting range of 100-135° C.

6. A multilayer film according to claim 1, wherein the outer layers comprise a low-density polyethylene (LDPE) or ultralow-density polyethylene having a density of from 0.925 to 0.940 g/cm³, a melt index MFI 190° C./2.16 kg of 0.1-22 g/10 min, and a melting range of 100-135° C.

7. A multilayer film according to claim 1, wherein the outer layers comprise a low-density polyethylene (LDPE) or ultralow-density polyethylene having a density of from 0.925 to 0.940 g/cm³, a melt index MFI 190° C./2.16 kg of 1-8 g/10 min, and a melting range of 100-135° C.

8. A process for producing a multilayer film according to claim 1, comprising:
shaping the polymer layers using a 5-layer coextrusion unit at temperatures of 200-250° C.; and
solidifying the polymer layers using a chill roll having a surface temperature of 40-70° C.

9. A process according to claim 8, wherein the step of solidifying comprises solidifying the polymer layers using a chill roll having a surface temperature of 50-60° C.

10. A label comprising a multilayer film according to claim 1.

11. A label affixed by an adhesive to a release liner made of abhesively coated film or paper wherein the label comprises a multilayer film acording to claim 1.

12. An adhesion-promoting composition for multilayer films for label material, comprising:
(i) 5-30% by weight of ULDPE (d ≦0.875),
(ii) 0-50% by weight of LDPE and/or LLDPE, and
(iii) 20-95% by weight of a random copolymer of polypropylene with a 1-alkylene having 4-20 carbon atoms.

13. An adhesion-promoting composition according to claim 12, wherein component (iii) comprises 5-25% 1-alkylene monomers and 95-75% propylene monomers.

14. An adhesion-promoting composition according to claim 13, wherein component (iii) comprises comonomers ranging from butene to octene.

15. An adhesion-promoting composition according to claim 12, wherein composition comprises a pigment.

16. An adhesion-promoting composition according to claim 12, wherein the composition comprises a filler.

17. An adhesion-promoting composition according to claim 16, wherein the filler comprises titanium dioxide or chalk.

18. A multilayer film comprising the adhesion-promoting composition according to claim 12.

19. A label comprising the multilayer film according to claim 18.
